(19) United States
(12) Patent Application Publication
(10) Pub. No.: US 2025/0348440 A1
(43) Pub. Date: Nov. 13, 2025

(54) Peripheral Device Connection Control Method, Apparatus, Electronic Device and Storage Medium

(71) Applicant: CLOUD INTELLIGENCE ASSETS HOLDING (SINGAPORE) PRIVATE LIMITED, Singapore (SG)

(72) Inventors: Zhiyu LI, Hangzhou, Zhejiang (CN); Chenguang YANG, Beijing (CN); Xiantao ZHANG, Hangzhou, Zhejiang (CN); Jinkui REN, Hangzhou, Zhejiang (CN)

(21) Appl. No.: 18/866,893

(22) PCT Filed: May 11, 2023
(86) PCT No.: PCT/CN2023/093403

§ 371 Date: Nov. 18, 2024

(30) Foreign Application Priority Data
May 16, 2022 (CN) 202210531519.7

(51) Int. Cl. G06F 13/10; G06F 13/40

(52) U.S. Cl. CPC G06F 13/10; G06F 13/4068; G06F 2213/40

(57) ABSTRACT

The embodiments of present disclosure provide a peripheral device connection control method, an apparatus, an electronic device, and a storage medium, the following technical solution includes that: in response to a focus of a computer switching to a first operation interface of multiple operation interfaces, a connection is established between an operating system of a background device corresponding to the first operation interface and a target peripheral device, where the target peripheral device includes a peripheral device connected with a first communication interface of the computer. According to the embodiments of the present disclosure, the connection between the peripheral device and the operating system of the background device corresponding to the operation interface can be established automatically by switching the focus.

The present disclosure claims priority of Chinese Patent Application No. 202210531519.7, filed to China Patent Office on May 16, 2022 and titled “Peripheral Device Connection Control Method, Apparatus, Electronic Device and Storage Medium”, the content of which is hereby incorporated by reference in its entirety.

### TECHNICAL FIELD

The present disclosure relates to the field of cloud computing, and in particular to a peripheral device connection control method, an apparatus, an electronic device and a storage Medium.

### BACKGROUND OF THE INVENTION

In general, for a peripheral device connected with a computer via a Universal Serial Bus (USB) interface, the peripheral device connects with one host at the same moment, which is not only a physical monolithic limitation, but also an architectural design limitation at a software level implemented based on a communication protocol and an Operating System (OS). Therefore, in a cloud scenario, when the peripheral device has been applied to a local desktop, a cloud desktop, or a cloud application, a host, with which the peripheral device is connected, is switched through manual configuration of a user in response to applying this peripheral device to another cloud desktop or another cloud application.

### SUMMARY OF THE INVENTION

Some embodiments of the present disclosure provide a peripheral device connection control method, an apparatus, an electronic device and a storage, so as to solve problems existed in the related art, and the technical solution is as follows.

In a first aspect, some embodiments of the present disclosure provide a peripheral device connection control method, including that:

in response to a focus of a computer switching to a first operation interface of multiple operation interfaces, a connection is established between an operating system of a background device corresponding to the first operation interface and a target peripheral device, where the target peripheral device includes a peripheral device connected with a first communication interface of the computer.

In a second aspect, some embodiments of the present disclosure provide a peripheral device connection control apparatus, including:

a processing module, arranged for, in response to a focus of a computer switching to a first operation interface of multiple operation interfaces, establishing a connection between an operating system of a background device corresponding to the first operation interface and a target peripheral device, where the target peripheral device includes a peripheral device connected with a first communication interface of the computer.

In a third aspect, some embodiments of the present disclosure provide an electronic device including a memory, a processor, and a computer program stored on the memory. The processor is arranged for implementing the method provided in any of the embodiments of the present disclosure when executing the computer program.

In a fourth aspect, some embodiments of the present disclosure provide a non-transitory storage medium, the non-transitory storage medium is arranged for storing the computer program, and the computer program, when executed by the processor, is used for implementing the method provided in any of the embodiments of the present disclosure.

In a fifth aspect, some embodiments of the present disclosure provide a computer program product including a computer program, and the computer program, when executed by the processor, is used for implementing the method provided in any of the embodiments of the present disclosure.

Through the technical solution of some embodiments of the present disclosure, for the peripheral device connected with the first communication interface of the computer, the connection is established between the operating system of the background device corresponding to the operation interface where the focus is located and the peripheral device by taking a switching of the focus of the computer as a triggering condition. Based on this, when the peripheral device is required to be applied to a certain operation interface, the connection between the operating system of the background device corresponding to this operation interface and the peripheral device can be established automatically by switching the focus.

The foregoing overview is for purposes of the specification and is not intended to be limiting in any way. In addition to the schematic aspects, implementation methods and features described above, further aspects, implementation methods and features of the present disclosure will be readily understood by reference to the accompanying drawings and the following detailed description.

### BRIEF DESCRIPTION OF DRAWINGS

In the accompanying drawings, unless otherwise specified, the same accompanying markings throughout the multiple accompanying drawings indicate the same or similar parts or elements. These accompanying drawings are not necessarily drawn to scale. It should be understood that these accompanying drawings depict some of the implementation methods disclosed in the present disclosure and should not be viewed as limiting the scope of the present disclosure.

FIG. 1 is a schematic diagram of an exemplary application scenario for realizing a method according to some embodiments of the present disclosure.

FIG. 2 is a flowchart of a peripheral device connection control method according to some embodiments of the present disclosure.

FIG. 3 is a flowchart of another peripheral device connection control method according to some embodiments of the present disclosure.

FIG. 4 is a schematic diagram of an example application of a method according to some embodiments of the present disclosure.

FIG. 5 is a structural block diagram of a peripheral device connection control apparatus according to some embodiments of the present disclosure.

FIG. 6 is a structural block diagram of an electronic device for realizing the method of some embodiments of the present disclosure.

### DETAILED DESCRIPTION OF THE INVENTION

In the following, certain exemplary embodiments are briefly described. As recognized by those skilled in the art, the described embodiments are modified in a variety of different ways without departing from the spirit or scope of the present disclosure. Accordingly, the accompanying drawings and descriptions are considered to be essentially exemplary and not limiting.

In order to facilitate the understanding of the technical solution of the embodiments of the present disclosure, the related art of some embodiments of the present disclosure are described below, and the related art, which are set as optional solutions, can be arbitrarily combined with the technical solution of some embodiments of the present disclosure, which all fall within the scope of protection of the embodiments of the present disclosure.

A peripheral device (which is also referred to as an external device or a peripheral), such as a USB flash drive, a printer, a signature pad, an overhead projector, etc., of a computer establishes a connection with the computer through a communication interface. The architecture of communication interface (such as USB) is a master-slave architecture. The peripheral device using this communication interface connects with one host and cannot be used by multiple hosts at the same time.

In a traditional peripheral device usage scenario, a complete plugging and unplugging process from a physical layer to a software layer is required for switching the host with which the peripheral device is connected.

In a cloud scenario, a local desktop provided by an operating system of a local computer, and a cloud desktop or cloud application provided by an operating system of a cloud server and presented using the local computer, are similarly not able to use such peripheral device at the same time. If the local computer is physically connected with the peripheral device, and the local computer maintains a network connection with an operating environment of the cloud desktop or cloud application, the local computer establishes a connection at the software level between the peripheral device and the local desktop, or between the peripheral device and the operating environment of the cloud desktop or cloud application, and switches the host with which the peripheral device is connected. This switching process can also be referred to as redirection.

In practice, taking USB as an example, unlike the local computer parsing interaction data between the cloud server and the USB, and transmitting the parsed data, USB redirection is required to establish a bidirectional and direct communication connection between the cloud server and an USB peripheral in order to transmit information based on an USB protocol between the cloud server and the USB peripheral. If the cloud desktop or cloud application wants to use the USB peripheral of the local computer (which can be understood as a local client of the cloud desktop or cloud application), it is necessary to establish a connection between the operating system of the cloud desktop or cloud application and the USB peripheral, protocol data of the USB is redirected from the local to the cloud desktop, and then an USB request of the cloud desktop is redirected to a local USB peripheral, so as to achieve the use of the USB peripheral by the cloud desktop or cloud application. In the related art, in the case where the USB peripheral is already used in one cloud desktop or cloud application, if the local computer or other cloud desktop or cloud application presented based on the local computer is required to use the USB peripheral, it is necessary for the user to be able to distinguish the operating environment of the cloud desktop or the cloud application, and to manually redirect the selection of the desktop according to the demand, leading to problems such as not being easy to use and not being convenient.

The technical solution of some embodiments of the present disclosure is mainly intended to solve the above technical problems. In order to more clearly demonstrate the peripheral device connection control method provided in some embodiments of the present disclosure, an application scenario that can be used to realize the method is first introduced.

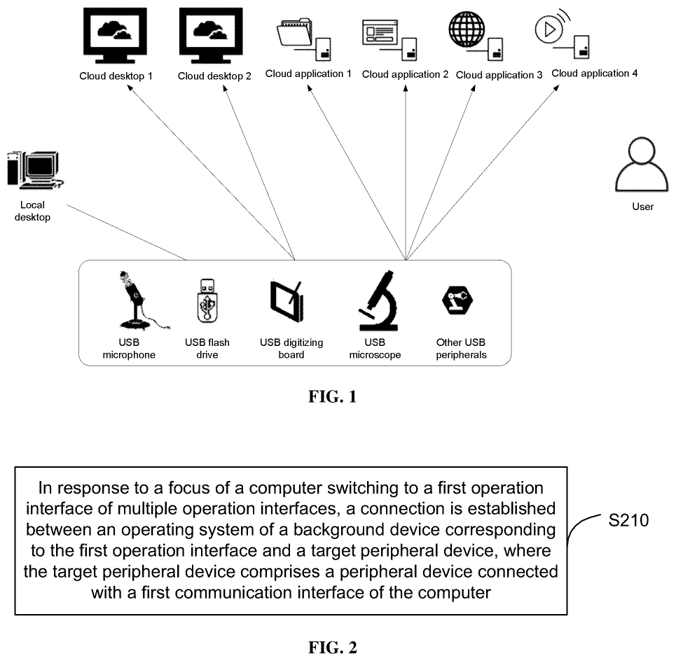

FIG. 1 illustrates an exemplary application scenario. In this application scenario, the computer establishes a physical layer connection with multiple peripheral devices. In other words, a connection between the computer and each peripheral device is established through a communication interface of the computer and a communication interface of each peripheral device. The multiple peripheral devices include, for example, an USB microphone, an USB flash drive, an USB digitizing board, an USB microscope, and other USB peripherals. Meanwhile, the computer is connected with the multiple cloud servers. The cloud desktops and/or cloud applications corresponding to the multiple cloud servers are presented to the user on an output device (such as a display) of the computer for operation by the user. Based on this, the computer outputs multiple operation interfaces, such as a local desktop, a cloud desktop, and a cloud application interface and so on. The user operates on one operation interface at the same time.

Since the operating environment of the cloud desktop and the cloud application is a complete operating system, many applications also require or even rely on USB peripherals for operation, and one USB peripheral is connected with one host at the same time, how to switch the connection of the USB peripherals is required to be considered to satisfy the peripheral usage demand for the local desktop, the cloud desktop and the cloud application, and so on. Some embodiments of the present disclosure take advantage of the fact that a user operates on one operation interface at the same time, and set the focus switching of the computer as a trigger condition to establish a connection between the operating system of the background device corresponding to the operation interface of the user and the peripheral device, so as to realize the automatic switching of the host with which the peripheral device is connected.

In order to be able to understand the features and technical contents of the embodiments of the present disclosure in more detail, the following are detailed description of the realization of some embodiments of the present disclosure in conjunction with the accompanying drawings, which are attached for illustrative purposes and are not intended to limit the embodiments of the present disclosure.

FIG. 2 illustrates a flowchart of a peripheral device connection control method according to some embodiments of the present disclosure. The method is optionally implemented by a computer, for example based on a peripheral device driver module or agent module configured on the computer, but is not limited thereto. As shown in FIG. 2, the method includes the following step.

In step S210, in response to a focus of a computer switching to a first operation interface of multiple operation interfaces, a connection is established between an operating system of a background device corresponding to the first operation interface and a target peripheral device, where the target peripheral device includes a peripheral device connected with a first communication interface of the computer.

In some embodiments of the present disclosure, the focus of the computer refers to an area, on which a user focuses, on an output device (such as a display) of the computer. Exemplarily, the focus of the computer is an area where a cursor is activated. For example, when a user focuses on a certain operation interface, an input cursor on the operation interface is activated by moving the mouse and clicking on the operation interface, or by clicking on a shortcut key on the keyboard for switching the focus, and all the information inputted by the user based on the input device (such as the keyboard, etc.) of the computer is presented on the operation interface.

In some embodiments of the present disclosure, the output device of the computer presents multiple operation interfaces, such that the focus of the computer can be switched between the multiple operation interfaces. Here, each of the multiple operation interface refers to a display interface for interacting with a user. Exemplarily, the multiple operation interfaces include at least one of a local desktop, a cloud desktop, and a cloud application interface. For example, the multiple operation interfaces include a local desktop and a cloud desktop, or the multiple operation interfaces include more than two cloud application interfaces, or the multiple operation interfaces include a local desktop, a cloud desktop and a cloud application interface, etc. Accordingly, in some embodiments of the present disclosure, the first operation interface is the operation interface where the focus is located after the focus switching. The first operation interface is a local desktop, a cloud desktop, or a cloud application interface.

The local desktop is the operation interface provided by the operating system of that computer. The cloud desktop and the cloud application interface are operation interfaces provided by an operating system of a remote server (such as a cloud server). At least one application interface is contained in the local desktop or the cloud desktop. For example, the local desktop includes operation interfaces for multiple local applications running based on resources of the local computer, and the cloud desktop includes operation interfaces for multiple applications running based on resources of the cloud server.

Exemplarily, in some embodiments of the present disclosure, the background device corresponding to the operation interface refer to a device for providing data of this operation interface to provide a user interaction service. For example, the background device corresponding to a cloud desktop includes a cloud server for providing data of the cloud desktop and running a background program of the cloud desktop. The background device corresponding to a cloud application interface includes a cloud server for providing cloud application data and running a background program of the cloud application. The background device corresponding to the local desktop is a local computer, that is, the computer in step S210 mentioned above.

Exemplarily, in some embodiments of the present disclosure, the target peripheral device is a specific peripheral device selected from at least one peripheral device connected with the first communication interface of the computer. For example, the user selects one of the at least one peripheral device as the target peripheral device to perform an automatic switching connection on the peripheral device, but not for other peripheral devices. The first communication interface is a peripheral device connected by a communication interface based on a master-slave architecture.

It is to be noted that in some embodiments of the present disclosure, the connection between the target peripheral device and the first communication interface of the computer is a physical connection, realized by a hardware docking between the communication interface of the peripheral device and the communication interface of the computer. The communication interface is an interface of a master-slave architecture, such as an USB interface.

In some embodiments of the present disclosure, for a remote server (namely the background device of the cloud desktop, the background device of the cloud application interface), in the case that a network connection is established between the background device and the local computer and a physical layer connection is established between the local computer and the peripheral device, the local computer can realize the connection between the operating system of the background device and the peripheral device, thereby realizing a master-slave connection from the physical level to the software level based on the communication interface, so that data can be transmitted between the background device, especially the remote server, and the peripheral device based on the communication interface protocol.

It is to be noted that in some embodiments of the present disclosure, the connection between the operating system of the background device and the target peripheral device refers to a protocol connection, that is, a connection for communication based on a communication protocol of the target peripheral device. Optionally, in some embodiments of the present disclosure, an operation of establishing the connection between the operating system of the background device corresponding to the first operation interface and the target peripheral device includes at least one of followings.

Protocol data sent by the target peripheral device is redirected to the operating system of the background device corresponding to the first operation interface; and a protocol request received by the background device based on the first operation interface is redirected to the target peripheral device.

The protocol refers to a communication protocol supported by the target peripheral device, and this protocol is also a communication protocol supported by the first communication interface, such as an USB protocol.

Taking a local computer as an example, in the case that the connection is established between the operating system of the local computer and the target peripheral device, a module for executing the above method redirects the protocol data of the target peripheral device to the operating system of the local computer. In the case that the connection is not established between the operating system of the local computer and the target peripheral device, and the connection is established between the target peripheral device and the operating system of the server of the cloud desktop, the module for executing the above method redirects the protocol data of the target peripheral device to the operating system of the server of the cloud desktop.

According to the above description, the technical solution of some embodiments of the present disclosure, for a peripheral device physically connected with a computer, a connection is established between an operating system of a background device corresponding to the operation interface where the focus is located and the peripheral device by taking a switching of the focus of the computer as a triggering condition. Based on this, when it is necessary to apply the peripheral device to a certain operation interface, the connection between the peripheral device of the background device corresponding to the operation interface and the peripheral device can be established automatically by switching the focus, so that the protocol data of the peripheral device is transmitted between the background device and the peripheral device. In this way, in a cloud scenario, the user is not required to distinguish the operating subject of the cloud desktop or the cloud application, and can automatically make the peripheral device follow the current focus for connection switching of the user.

Optionally, in the step S210, an operation of, in response to the focus of the computer switching to the first operation interface of the multiple operation interfaces, establishing the connection between the operating system of the background device corresponding to the first operation interface and the target peripheral device include the following steps.

In response to the focus switching from a second operation interface of the multiple operation interfaces to the first operation interface, the connection is disconnected between an operating system of a background device corresponding to the second operation interface and the target peripheral device, and the connection is established between the operating system of the background device corresponding to the first operation interface and the target peripheral device.

That is, in the above optional solution, the connection between the operating system of the background device corresponding to the second operation interface and the peripheral device is disconnected before establishing the connection between the operating system of the background device corresponding to the first operation interface and the peripheral device. In this way, the restrictive requirement that the peripheral device is connected with one host at the same time can be satisfied.

Optionally, an operation of disconnecting the connection between the operating system of the background device corresponding to the second operation interface and the peripheral device includes the following step.

In the case that the target peripheral device is in an idle state, the connection between the operating system of the background device corresponding to the second operation interface and the target peripheral device is disconnected.

That is, if the target peripheral device has a background operation state, for example, if the target peripheral device is a USB flash drive, a high-fidelity camera, a printer, etc., which will run continuously in the background, it is necessary to maintain the background operation state of the target peripheral device, and to disconnect the connection between the operating system of the background device corresponding to the second operation interface and the target peripheral device in the case that the target peripheral device is in an idle state. In this way, the work interruption of the target peripheral device and the loss of user information can be avoided.

Exemplarily, the focus of the computer is obtained when the target peripheral device is in an idle state to follow the focus switching for connection switching of the peripheral device. Alternatively, the focus of the computer is kept to be obtained and after determining that the focus is switched to the first operation interface, the background operation state of the target peripheral device is determined.

In practice, the background operation state of the target peripheral device is obtained by detecting activity data of the target peripheral device. For example, when no activity data of the target peripheral device is detected for a preset time period, the target peripheral device is determined in an idle state.

Optionally, if the target peripheral device does not have a background operation state, for example, if the target peripheral device is a 3D mouse, a signature board, and a drawing board, etc., since data transmission of the target peripheral device is triggered in real time based on user inputs, and the target peripheral device is not continuously running in the background, it is possible to directly disconnect the connection between the target peripheral device and the second operation interface when the focus is switched from the second operation interface to the first operation interface.

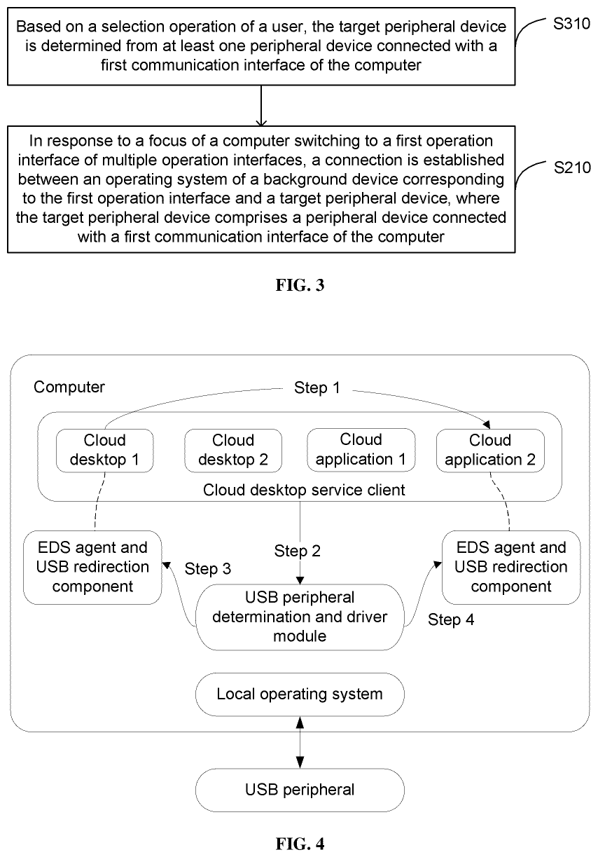

Optionally, as shown in FIG. 3, the above method further includes the following steps.

In step S310, based on a selection operation of a user, the target peripheral device is determined from at least one peripheral device connected with a first communication interface of the computer.

For example, based on one application interface on a local desktop, an information list about the peripheral device connected with the first communication interface is displayed, so as to enable a user to select at least one device from the information list as the target peripheral device, thereby following the focus switching, connection switching can be performed for the selected peripheral device.

Exemplarily, the first communication interface is a master-slave architecture communication interface.

According to the above method, it is possible to make the connection switching of the peripheral devices for part of the peripheral devices in demand, instead of all of the peripheral devices connected with the computer. For example, the user selects the connection of the peripheral device such as a USB flash drive, a high-fidelity camera, and other peripheral devices to follow the focus for switching, so as to realize the sharing of these peripheral devices by a local desktop, a cloud desktop, and a cloud application. As for peripheral devices such as a mouse and a keyboard, the sharing of these peripheral devices can be realized by using the local computer to parse the input data of the peripheral devices and transmit the parsed data to the background devices of the cloud desktop and cloud application.

In order to present the technical ideas of the present disclosure more clearly, a specific application example is provided below using a USB peripheral as an example.

As shown in FIG. 4, a local operating system, an USB peripheral determination and driver module, an Elastic Desktop Service (EDS) agent and USB redirection component, and a cloud desktop service client are arranged on the computer. The cloud desktop service client provides multiple operation interfaces. The multiple operation interfaces include multiple cloud desktops and multiple cloud application interfaces, such as a cloud desktop 1, a cloud desktop 2, a cloud application 1, and a cloud application 2. The USB peripheral connection control method includes the following steps.

In step 1, a user clicks or switches a focus to an operation interface, such as switching the focus from the cloud desktop 1 to the cloud application 2.

In step 2, the USB peripheral determination and driver module detects the switching of the focus.

In step 3, the USB peripheral determination and driver module disconnects a connection between the USB peripheral and the cloud desktop 1 through the EDS agent and USB redirection component of the cloud desktop 1.

In step 4, the USB peripheral determination and driver module establishes a connection between the USB peripheral and the cloud application 2 through the EDS agent and USB redirection component of the cloud application 2.

Through the execution of the above steps, the USB peripheral determination and driver module obtains data transmitted by the USB peripheral to an USB protocol stack of the local operating system, and based on the connection between the USB peripheral and the cloud application 2, the data is transmitted to the operating environment of the cloud application 2, that is, the operating system of the background device corresponding to the cloud application 2, so that the background device corresponding to the cloud application 2 can read information of the USB peripheral to interact with the USB peripheral.

It should be noted that although the peripheral device connection control method is introduced as above taking the USB as an example, those skilled person in the art can understand that the present disclosure shall not be limited thereto. In fact, as long as the peripheral device is connected with the computer using the communication interface of the master-slave architecture, the connection switching can be realized using the above method.

In this way, for a peripheral device connected with a computer, according to the method of the above embodiments of the present disclosure, when the peripheral device is required to be applied to a certain operation interface, a connection between the peripheral device and the operating system of the background device corresponding to that operation interface can be automatically established by switching the focus.

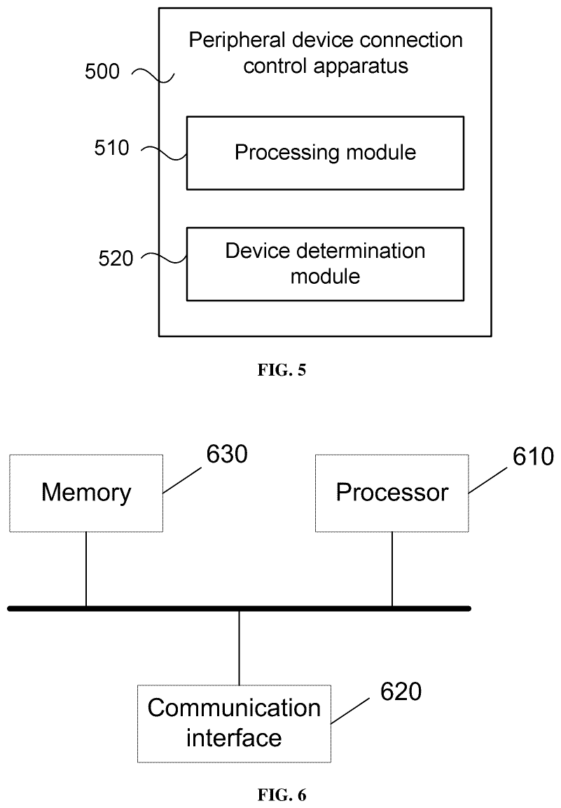

Corresponding to the application scenario of the method provided by some embodiments of the present disclosure and the method, some embodiments of the present disclosure further provide a peripheral device connection control apparatus 500. As shown in FIG. 5, the apparatus 500 includes:

processing module 510, arranged for, in response to a focus of a computer switching to a first operation interface of multiple operation interfaces, establishing a connection between an operating system of a background device corresponding to the first operation interface and a target peripheral device, where the target peripheral device includes a peripheral device connected with a first communication interface of the computer.

Exemplarily, the multiple operation interfaces includes at least one of a local desktop, a cloud desktop, and a cloud application interface.

Exemplarily, the processing module 510 is further arranged for:

in response to the focus switching from a second operation interface of the multiple operation interfaces to the first operation interface, disconnecting the connection between an operating system of a background device corresponding to the second operation interface and the target peripheral device, and establishing the connection between the operating system of the background device corresponding to the first operation interface and the target peripheral device.

Exemplarily, the processing module 510 is further arranged for:

disconnecting the connection between the operating system of the background device corresponding to the second operation interface and the target peripheral device when the target peripheral device is in an idle state.

Exemplarily, as shown in FIG. 5, the apparatus further includes:

device determination module 520, arranged for, based on a selection operation of a user, determining the target peripheral device from at least one peripheral device connected with a first communication interface of the computer.

Exemplarily, the first communication interface is a master-slave architecture communication interface.

The functions of each module in each apparatus of the embodiments of the present disclosure can be found in the corresponding descriptions in the method described above, and have corresponding beneficial effects, which will not be repeated herein.

Some embodiments of the present disclosure further provide an electronic device for realizing the above method. FIG. 6 illustrates a structural block diagram of an electronic device according to some embodiments of the present disclosure. As shown in FIG. 6, the electronic device includes: a memory 610 and a processor 620, and the memory 610 is arranged for storing a computer program running on the processor 620. The processor 620 is arranged for executing the computer program to realize the peripheral device connection control method in the above embodiments. The number of the memory 610 and the processor 620 is at least one.

The electronic device further includes:

communication interface 630, arranged for communicating with an external device for interactive data transmission.

If the memory 610, the processor 620, and the communication interface 630 are implemented independently, the memory 610, the processor 620, and the communication interface 630 are connected with each other and accomplish communication with each other via a bus. The bus is an Industry Standard Architecture (ISA) bus, a Peripheral Component Interconnect (PCI) bus, or an Extended Industry Standard Architecture (EISA) bus, etc. The bus is categorized as an address bus, data bus, control bus, etc. For ease of representation, FIG. 6 is represented by one bold line, but does not indicate that there is only one bus or one type of bus.

Optionally, in a specific implementation, if the memory 610, the processor 620, and the communication interface 630 are integrated on a single chip, the memory 610, the processor 620, and the communication interface 630 complete communication with each other through an internal interface.

Some embodiments of the present disclosure further provide a computer-readable storage medium storing a computer program, and the computer program is executed by a processor to implement the method provided in any embodiment of the present disclosure.

Some embodiments of the present disclosure further provide a computer program product including a computer program, and the computer program executed by a processor to implement the method provided in any embodiment of the present disclosure.

Some embodiments of the present disclosure further provide a chip including a processor for calling instructions from a memory and running the instructions, and a communication device, in which the chip is installed, is caused to execute a method provided by embodiments of the present disclosure.

Some embodiments of the present disclosure further provide a chip, including: an input interface, an output interface, a processor, and a memory. The input interface, the output interface, the processor, and the memory are connected with each other by an internal connection pathway. The processor is arranged for executing codes in the memory, and the processor is arranged for executing the method provided by some embodiments of the present disclosure when the codes are executed.

It should be understood that the above processor is a Central Processing Unit (CPU), or other general-purpose processor, a Digital Signal Processing (DSP), an Application Specific Integrated Circuit (ASIC), a Field Programmable Gate Array (FPGA), or other programmable logic device, a discrete gate or a transistorized logic device, a discrete hardware component, etc. The general-purpose processor is a microprocessor or any conventional processor, etc. It is noted that the processor is a processor supporting an Advanced RISC Machines (ARM) architecture.

Further, optionally, the memory described above includes a read-only memory and a random access memory, and further includes a non-transitory random access memory. The memory is a transitory memory or non-transitory memory, or includes both the transitory memory and the non-transitory memory. The non-transitory memory includes a Read-only Memory (ROM), a Programmable Read-only Memory (PROM), an Erasable Programmable Read-only Memory (EPROM), an Electrically Erasable Programmable Read-only Memory (EEPROM), or a flash memory. The transitory memory includes a Random Access Memory (RAM), which is used as an external cache. By way of exemplary but not limiting illustration, many forms of RAM are available. For example, a Static Random Access Memory (SRAM), a Dynamic Random Access Memory (DRAM), a Synchronous Dynamic Random Access Memory (SDRAM), a Double Data Rate Synchronous Dynamic Random Access Memory (DDR SDRAM), an Enhanced Synchronous Dynamic Random Access Memory (ESDRAM), a Sync Link Dynamic Random Access Memory (SLDRAM), and a Direct Rambus Random Access Memory (DRRAM).

In the above embodiments, these embodiments can be implemented in whole or in part by software, hardware, firmware, or any combination thereof. When implemented using software, these embodiments can be implemented, in whole or in part, in the form of a computer program product. The computer program product includes at least one computer instruction. When loaded and executed on a computer, the computer program instructions can produce, in whole or in part, a process or function in accordance with the present disclosure. The computer is a general-purpose computer, a specialized computer, a computer network, or other programmable device. The computer instructions are stored in a non-transitory storage medium or transmitted from one non-transitory storage medium to another non-transitory storage medium.

In the description of this specification, the description of reference to the terms “an embodiment”, “some embodiments”, “examples”, “specific examples”, or “some examples”, etc. means that the specific features, structures, materials, or characteristics described in conjunction with the embodiment or example are included in at least one embodiment or example of the present disclosure. Moreover, the specific features, structures, materials, or characteristics described are combined in any at least one of the embodiments or examples in a suitable manner. In addition, without contradicting each other, those skilled person in the art can combine different embodiments or examples and features of different embodiments or examples described in this specification.

Furthermore, the terms “first” and “second” are used for describing purposes and are not to be understood as indicating or implying relative importance or implicitly specifying the number of technical features indicated. Thus, features defined with the terms “first”, “second” expressly or impliedly include at least one such feature. In the description of the present disclosure, “more than one” means two or more, unless otherwise expressly and specifically limited.

Any process or method description depicted in the flowchart or otherwise described herein can be understood to represent a module, fragment, or portion of code that includes at least one executable instruction for implementing the steps of a particular logical function or process. And the scope of the optional embodiments of the present disclosure includes additional implementations in which functions can be performed in a substantially simultaneous manner or in reverse order, depending on the function involved, not in the order shown or discussed.

The logic and/or steps represented in the flowchart or otherwise described herein, for example, can be considered as a sequential list of executable instructions for implementing the logic functions, and can be specifically implemented in any non-transitory medium for use by an instruction-executing system, device, or apparatus (such as based on a computer system, including a processor system, or other system that can fetch instructions from an instruction-executing system, device, or apparatus and execute the instructions), or in combination with such instruction execution systems, devices, or equipment.

It should be appreciated that various portions of the present disclosure can be implemented with hardware, software, firmware, or combinations thereof. In the embodiments described above, multiple steps or methods can be implemented with software or firmware stored in memory and executed by a suitable instruction execution system. All or some of the steps of the method of the above embodiments are accomplishable by a program to instruct the associated hardware, and the program can be stored in a non-transitory storage medium, when executed, includes one of the steps of the method embodiments or a combination thereof. In addition, the various functional units in various embodiments of the present disclosure can be integrated in a single processing module, or the individual units may physically exist separately, or two or more units can be integrated in a single module. The above integrated modules can be realized either in the form of hardware or in the form of software function modules. The above-described integrated module is further stored in a non-transitory storage medium if it is realized in the form of a software function module and sold or used as a separate product. The storage medium can be a read-only memory, a disk or an optical disk, etc.

Above are the specific embodiments of the present disclosure, but the scope of protection of the present disclosure is not limited thereto, and those skilled person in the art familiar with the technical field can easily think of various variations or substitutions thereof within the scope of the technology disclosed in the present disclosure, which shall be covered by the scope of protection of the present disclosure. Therefore, the scope of protection of this disclosure shall be subject to the scope of protection of the claims.

1. A peripheral device connection control method, comprising:
in response to a focus of a computer switching to a first operation interface of a plurality of operation interfaces, establishing a connection between an operating system of a background device corresponding to the first operation interface and a target peripheral device, wherein the target peripheral device comprises a peripheral device connected with a first communication interface of the computer.

2. The method as claimed in claim 1, wherein the plurality of operation interfaces comprise at least one of a local desktop, a cloud desktop, and a cloud application interface.

3. The method as claimed in claim 1, wherein in response to the focus of the computer switching to the first operation interface of the plurality of operation interfaces, establishing the connection between the operating system of the background device corresponding to the first operation interface and the target peripheral device, comprises:
in response to the focus switching from a second operation interface of the plurality of operation interfaces to the first operation interface, disconnecting the connection between an operating system of a background device corresponding to the second operation interface and the target peripheral device, and establishing the connection between the operating system of the background device corresponding to the first operation interface and the target peripheral device.

4. The method as claimed in claim 3, wherein disconnecting the connection between the operating system of the background device corresponding to the second operation interface and the target peripheral device comprises:
disconnecting the connection between the operating system of the background device corresponding to the second operation interface and the target peripheral device when the target peripheral device is in an idle state.

5. The method as claimed in claim 1, wherein establishing the connection between the operating system of the background device corresponding to the first operation interface and the target peripheral device comprises at least one of followings:
redirecting protocol data sent by the target peripheral device to the operating system of the background device corresponding to the first operation interface; and
redirecting a protocol request received by the background device based on the first operation interface to the target peripheral device.

6. The method as claimed in claim 1, further comprising:
based on a selection operation of a user, determining the target peripheral device from at least one peripheral device connected with a first communication interface of the computer.

7. The method as claimed in claim 6, wherein the first communication interface is a master-slave architecture communication interface.

8. (canceled)

9. An electronic device, comprising a memory, a processor, and a computer program stored in the memory, wherein the processor implements the following step:
in response to a focus of a computer switching to a first operation interface of a plurality of operation interfaces, establishing a connection between an operating system of a background device corresponding to the first operation interface and a target peripheral device, wherein the target peripheral device comprises a peripheral device connected with a first communication interface of the computer.

10. A non-transitory storage medium, comprising a computer program, wherein the processor executes the computer program to implement the following step:
in response to a focus of a computer switching to a first operation interface of a plurality of operation interfaces, establishing a connection between an operating system of a background device corresponding to the first operation interface and a target peripheral device, wherein the target peripheral device comprises a peripheral device connected with a first communication interface of the computer.

11. (canceled)

12. The method as claimed in claim 1, wherein the method is applied to a peripheral device driver module or proxy module arranged on the computer.

13. The method as claimed in claim 1, wherein the focus is an area on an output device of the computer that a user pays attention to.

14. The method as claimed in claim 13, wherein the focus is an area where a cursor is activated.

15. The method as claimed in claim 13, wherein the focus switches between the plurality of operation interfaces presented on the output device.

16. The method as claimed in claim 15, wherein the first operation interface is the local desktop, cloud desktop, or cloud application interface where the focus is located after switching.

17. The method as claimed in claim 16, wherein the local desktop is an operation interface provided by the operating system of the computer.

18. The method as claimed in claim 16, wherein the cloud desktop and the cloud application interface are operation interfaces provided by an operating system of a remote server.

19. The method as claimed in claim 1, wherein the background device corresponding to the first operation interface is a device for providing data for the first operation interface to provide user interaction service.

20. The method as claimed in claim 1, wherein the connection between the operating system of the background device corresponding to the first operation interface and the target peripheral device is a connection for communication based on a communication protocol of the target peripheral device.

21. The method as claimed in claim 4, further comprising:
obtaining the focus when the target peripheral device is in the idle state.

22. The method as claimed in claim 4, wherein a background operation state of the target peripheral device is determined by detecting activity data of the target peripheral device.
